(19) United States
(12) Patent Application Publication
(10) Pub. No.: US 2008/0313966 A1
(43) Pub. Date: Dec. 25, 2008

(54) Door Module for a Vehicle Door

(76) Inventor: Bernhard Sielhorst, Sontra (DE)

Correspondence Address: FAY KAPLUN & MARCIN, LLP, 150 BROADWAY, SUITE 702, NEW YORK, NY, 10038, US

(21) Appl. No.: 11/631,537

(22) PCT Filed: Jul. 6, 2005
(86) PCT No.: PCT/EP2005/007440

§ 371 Date: Feb. 15, 2008

(30) Foreign Application Priority Data
Jul. 6, 2004 (DE) 10 2004 033 583.4

(51) Int. Cl. B60J 5/04

(52) U.S. Cl. 49/502

(57) ABSTRACT

A door- or side wall module is made of plastic material and utilized for a vehicle door or a vehicle side wall for separating a wet side from a dry side. The door- or side wall module forms a support for a window lifting mechanism and a toothed transmission part which is associated with the window lifting mechanism is moulded in one piece onto the door- or side wall module. The window lifting arrangement comprises such a door- or side wall module and to a vehicle door with a corresponding door module or with a corresponding window lifting arrangement, and also to a method for producing a door- or side wall module of this type.

### FIELD OF INVENTION

The present invention relates to a door- or side wall module made of plastic material for a vehicle door or vehicle side wall for separating a wet side from a dry side. The invention relates furthermore to a window lifting arrangement which comprises such a door- or side wall module, and to a vehicle door with such a door module or with such a window lifting arrangement and also to a method for producing a corresponding door- or side wall module.

### BACKGROUND INFORMATION

Such a door- or side wall module serves, on the one hand, for separating a wet side from a dry side in a vehicle door or side wall, typically in a door or side wall of an automotive vehicle and, on the other hand, as a support for a window lifting mechanism which serves, for its part, for driving a window pane which is disposed moveably, preferably displaceably, for opening and closing a window. In the case of conventional door modules according to prior art, it is provided to dispose a transmission in addition on the door module which has a drive shaft which is connected to a motor or a winder drive and also a driven shaft, the driven shaft actuating a Bowden cable for the window pane via a drum. The transmission is thereby typically produced by a toothed wheel which is disposed on the driven shaft and by a worm wheel which is connected to the drive shaft, together with the motor forming a worm drive.

Worm drives of this type have however disadvantageously low efficiency, which means that drive motors of disproportionately high power are required. A crucial disadvantage of window lifting arrangements of the described type resides however in a relatively complex construction which, in addition to the door module which functions as support, requires a large number of independent moveable parts which must be produced and mounted separately. A large parts requirement, on the one hand, and high assembly complexity, on the other hand, are therefore involved therewith.

### SUMMARY OF INVENTION

The present invention relates to a corresponding door module or side wall module and a corresponding window lifting arrangement and also a production method therefor. The door- or side wall module which serves as support for a window lifting mechanism and a window lifting arrangement which comprises such a door- or side wall module, with which a window actuation can be produced with as high efficiency as possible and as low production complexity as possible.

A simple construction, as required, of a window lifting arrangement which is based on a door- or side wall module according to the invention is produced in that at least one toothed transmission part associated with the window lifting mechanism is moulded in one piece onto the door- or side wall module.

Such a door- or side wall module can be produced in a particularly simple manner in that it is cast together with the transmission part in one operation in an injection moulding process. The transmission part which is toothed in the desired form can thereby be produced with the help of a correspondingly configured casting mould. Another, likewise simple production method provides that the transmission part is injection-moulded onto the door module. If here and further on only door modules are of concern, then what has been said applies similarly also to side wall modules which are not installed in doors. In order to injection-mould on the transmission part, the door module which was produced previously for example by a different injection moulding process can be inserted into a cavity which is provided separately for injection-moulding on the transmission part.

However, it is also possible to produce the door module with the toothed transmission part in a two-component injection moulding process in which two different plastic material components are injected into a cavity so that a plastic material component forms a supporting part of the door module, whereas the transmission part is formed by a different plastic material component. This production method is particularly advantageous when the first-mentioned plastic material component, for example as a result of a glass fibre content, does not permit adequately precise production of a tooth geometry of the transmission part. As a second plastic material component, for example a plastic material without fibre reinforcement or with shorter fibres could then be used.

Finally, another production method for a door module according to the invention provides that the transmission part to be moulded in one piece onto the door module is produced by deep drawing or embossing of the door module. The door module could then have been produced in advance as an injection moulded part or be produced together with the transmission part in one injection-embossing process or by embossing or deep drawing of a semi-finished product.

Relatively low complexity for the production of the door module with the transmission part which then forms an integral component of the door module is common to all the portrayed production methods.

It is particularly advantageous to manufacture the door module at least partially from polypropylene or polyamide, both being materials which can be processed, on the one hand, particularly well in the described manner and, on the other hand, permit a sufficiently stable embodiment of the door module. High stability of the door module, which is of advantage because the door module is intended to function in particular as support for the window lifting mechanism, can be produced also in that the door module is manufactured at least partially from a fibre-reinforced plastic material. This can be achieved particularly economically by using glass fibre-reinforced plastic material, use of long glass fibre-reinforced plastic material—preferably with a glass-fibre proportion of the order of magnitude of 30 percent by weight—being particularly advantageous with respect to stability.

An advantageous embodiment of the invention provides that the door module has at least one toothed rack which functions as transmission part and is moulded in one piece onto the door module, preferably with an essentially vertical course. Such a toothed rack can be embodied for example as a bead, as a web or even as an L-profile which is moulded onto the door module. A particularly expedient window lifting mechanism can thereby be achieved if the toothed rack is disposed on the wet side of the door module. Toothed, oblong transmission parts should also be termed here as toothed racks if they have a slightly curved course, i.e. not only toothed racks with an exactly straight course but also for example tooth segments with a radius of curvature which is large compared to the total length of the toothed rack (or of the tooth segment).

A window lifting arrangement is produced which has a particularly clear construction and operates at high efficiency when using a door module with at least one toothed rack as the transmission part which is moulded onto the door module if this window lifting arrangement has in addition an entrainer for a window pane which comprises a motor, a toothed wheel which is driven by the motor being in engagement with the toothed rack. An additional simplification in the construction can be achieved if the toothed rack is configured at the same time as guide rail for the entrainer. The possibility then arises that further guide means for the window pane which is actuated by the window lifting mechanism is very extensively superfluous. A guide of the entrainer with the motor and hence a guide of the window pane can be achieved for example in that a rotatable counter-roller is disposed on the entrainer such that the toothed rack is situated between the counter-roller and the toothed wheel which is actuated by the motor. A particularly precise guidance of the entrainer and of the window pane can thus be achieved, in particular in those embodiments in which the toothed rack is configured as a web or an L-profile.

Another embodiment of the invention provides that a ring with inner toothing is moulded in one piece onto the door module as transmission part. The ring with inner toothing is thereby intended to form a part of a transmission which belongs to the corresponding window lifting mechanism. If the ring with inner toothing is thereby disposed on the dry side of the door module, this transmission can likewise be disposed at least as far as possible on the dry side and consequently advantageously be protected from water spray. A particularly advantageous window lifting arrangement is produced with such a door module if the transmission, of which the ring with inner toothing forms a component, has a drive shaft which is connected to a motor or to a hand winder and a driven shaft for driving a pulling device for a moveable window pane. If the ring with inner toothing is disposed as described on the dry side, the driven shaft can be configured preferably to pierce the door module and thus to lead from the dry side to the wet side. Sealing of the driven shaft relative to the door module which is intended to prevent penetration of water to the dry side, can be achieved thereby in a relatively simple manner. The pulling device for the moveable, typically displaceable, window pane can be provided in particularly uncomplicated embodiments of the invention, for example by a drum which is driven by the driven shaft and is seated preferably on the driven shaft and a traction rope which is guided over this drum and can be connected via guide and/or deflection means to the window pane or to an entrainer for the window pane. It would also be conceivable for example to drive a pinion via the driven shaft, over which pinion a chain is guided.

In embodiments of the invention of the last-described type with an internally toothed ring as transmission part which is moulded onto the door module, it is possible to configure the corresponding transmission as a planetary gear. For example a sun wheel of this planetary gear can then sit on the drive shaft, whilst a mounting (also termed “cage”) of planet wheels which roll on this sun wheel and on the ring with the inner toothing drives the driven shaft. A reverse arrangement would also be possible, i.e. an exchange of drive shaft and driven shaft. As a function thereof and according to the relative dimensioning of the sun wheel and of the planet wheels, a desired gear reduction can hence be achieved (normally required with a motor drive) or also gearing up (possibly desired in the case of a hand winder drive), a force or torque transmission being achieved in each case with particularly high efficiency.

A more simple, more economical and hence particularly advantageous construction is however obtained if the ring with the inner toothing forms a support ring of a so-called harmonic drive transmission. Harmonic drive transmissions of this type, in which a flexible, externally toothed rolling bush rolls internally on the support ring but abuts thereby on the support ring only at points, actuation of the transmission being effected via a core which rotates within the rolling bush and has a non-constant radius, are known per se from other applications and are characterised in that a high gear reduction ratio and particularly high efficiency are made possible at the same time with a very simple construction. Preferred embodiments of transmissions of this type, which are particularly advantageous with respect to efficiency and as low as possible wear and tear, thereby have, between the rolling bush and the core which is disposed within the rolling bush, a ball bearing or roller bearing. In the case of the application which is proposed here of a harmonic drive transmission for a window lifting mechanism, the rolling bush (produced for example by a flexible toothed belt which is closed per se) can be connected in a particularly simple manner directly or indirectly to a driven shaft in order to drive a pulling device for the corresponding window pane.

A door module or a window lifting arrangement of the type described here can be disposed in a particularly advantageous manner in a vehicle door. It is however also possible to dispose a corresponding side wall module in a vehicle side wall wherever the latter in fact has a window to be opened and to be closed by displacing a window pane but has no door. Both the described embodiments of the invention with transmission parts which are configured as toothed racks and moulded onto the corresponding door or side wall module and those arrangements in which an internally toothed ring forms a moulded-on transmission part are thereby characterised in that they allow production of window pane drives which have particularly high efficiency, as a result of which use of less powerful and hence smaller and cheaper motors is in turn made possible.

### BRIEF DESCRIPTION OF DRAWINGS

Embodiments of the invention are explained in the following with reference to FIGS. 1 to 6, which show

FIG. 1 shows a door module according to an exemplary embodiment of the present invention,

FIG. 2 shows a section through a door module according to the present invention with an entrainer for a window pane,

FIG. 3 shows a section of another door module according to the present invention with an entrainer and a window pane in an opened-out representation,

FIG. 4 shows a schematic representation of a vehicle door with a door module in a further exemplary embodiment of the present invention,

FIG. 5 shows a view of a section of the door module of FIG. 4 and

FIG. 6 shows a cross-section through a door module with a window lifting mechanism in a similar exemplary embodiment of the present invention.

### DETAILED DESCRIPTION

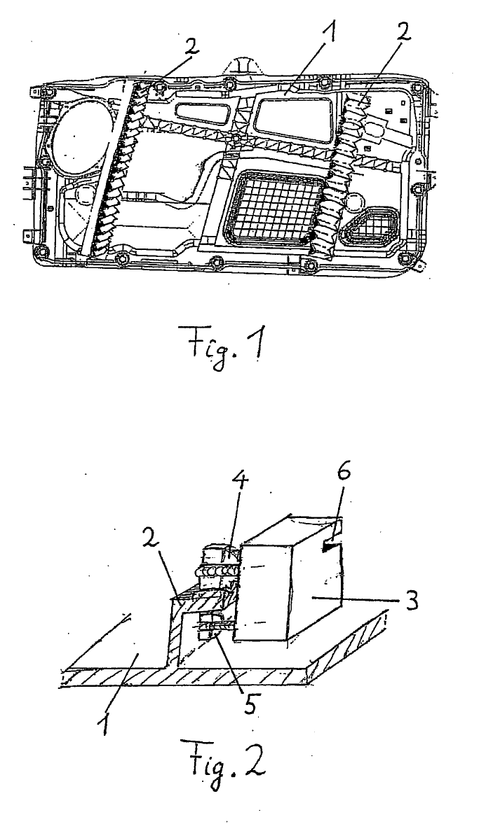

In FIG. 1, a door module 1 is illustrated made of a long glass fibre-reinforced plastic material which concerns an injection moulded part. This door module 1 is, in the present case, manufactured from a polypropylene with a glass fibre proportion of approx. 30 percent by weight, however other plastic materials, such as for example polyamides, can also be used similarly to produce such a door module 1. The illustrated door module 1 is provided for installation in a side door of an automotive vehicle in order to serve there for separating a wet side from a dry side in the vehicle door and as a support for a window lifting mechanism. In the same manner, side wall modules can also be configured for installation in a vehicle side wall at a position at which the latter has no door.

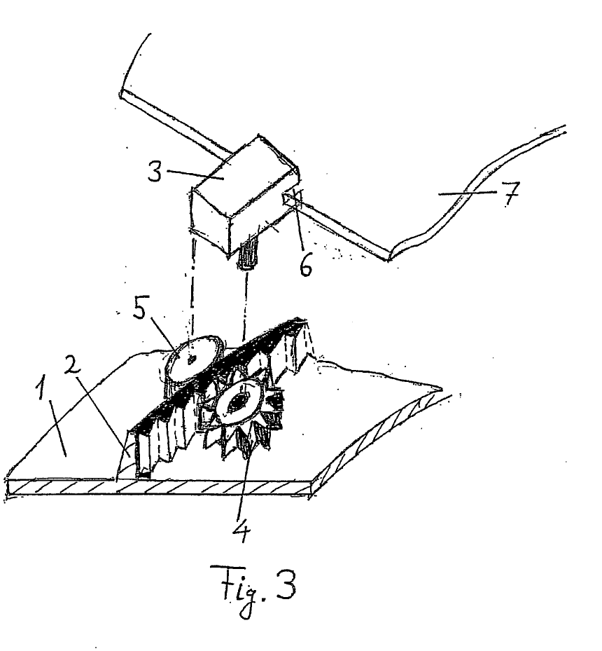

Two transmission parts 2 which belong to the mentioned window lifting mechanism are moulded in one piece onto the door module 1 and concern in the present case toothed racks. The toothed rack illustrated on the left in FIG. 1 is thereby configured as a web which is moulded onto the door module 1 or as a bead, the toothed rack illustrated on the right in FIG. 1 as an L-profile which is moulded onto the door module 1. These two transmission parts 2, which are disposed on the wet side, illustrated in FIG. 1 (i.e. on a side pointing towards the vehicle interior in the assembled state) of the door module 1, have a function which is explained in the following with reference to FIGS. 2 and 3.

In FIG. 2, again a door module 1 with a transmission part 2 which is moulded in one piece onto the door module 1 can be seen. This transmission part 2 is configured as an L-profile and has a toothing on a side pointing away from the door module 1. An entrainer 3 for a window pane, not illustrated in FIG. 2, into which an electric motor is integrated, can likewise be detected. This electric motor drives a toothed wheel 4 which is in engagement with the transmission part 2, i.e. with the toothed rack which is configured as an L-profile. The L-profile thereby serves at the same time as guide rail for the entrainer 3, guidance of the entrainer 3 being achieved in that a rotatable counter-roller 5 is disposed on the entrainer 3 such that the toothed rack is situated between the counter-roller 5 and the mentioned toothed wheel 4. The entrainer 3 has furthermore a slot 6 for receiving the window pane, not illustrated here. A window lifting arrangement, which has a door module 1 and an entrainer 3 of the described type, allows displacement of the window pane by the electric motor which is disposed in the entrainer 3 and consequently opening and closing of a corresponding window in that the entrainer 3 moves along the transmission part 2 which is configured as a toothed rack and is moulded onto the door module 1.

A very similar arrangement is shown in FIG. 3. A difference arises here only in that the toothed rack which forms the transmission part 2 is moulded onto the door module 1 as web or bead. An entrainer 3, which receives a window pane 7 in a slot 6, is also provided here, an electric motor which is disposed in this entrainer 3 driving a toothed wheel 4 which is in engagement with the transmission part 2. Recurring features are provided here again with the same reference numbers.

In FIG. 4, a part of a vehicle door with a door module 1 according to the invention is illustrated in another embodiment. The door module 1 is disposed on a door internal metal sheet 8 and thus covers an opening in this door internal metal sheet 8. A window pane 7, which abuts on a door or window frame 9 when the window is closed, is configured to be displaceable upwards and downwards for opening and closing. A lower edge 10 of the window pane 7 which is retained by an entrainer 3 thereby moves along a wet side of the door module 1, i.e. on a side which points outwardly when the door is installed. The door module 1 thereby serves not only for separating the wet side from the dry side which points towards the vehicle interior when the door is installed but also as a support for a window lifting mechanism which enables an upwards and downwards movement of the entrainer 3 and hence of the window pane 7.

This window lifting mechanism comprises a transmission which has a drive shaft which is connected to an electric motor (instead of the electric motor also a winder drive could be used) and a driven shaft for driving a pulling device for the moveable window pane 7. The pulling device thereby comprises a drum 11 which sits on the driven shaft of the transmission, a traction rope 12 which is guided over this drum 11, and two deflection elements 13 (in the present case rollers) via which the traction rope 12 is likewise guided. The two ends of the traction rope 12 are connected to the entrainer 3.

A component of the mentioned transmission, namely a transmission part 2 which is configured as a ring with inner toothing, is moulded in one piece onto the door module 1. This ring with inner toothing is disposed on the dry side of the door module, i.e. is situated accessible from the dry side. The mentioned transmission concerns a so-called harmonic drive transmission, the mentioned transmission part 2, i.e. the ring with inner toothing, forming a support ring of this harmonic drive transmission. As an alternative, it is also possible to configure the transmission as a planetary gear, the ring with inner toothing then serving as external toothed ring of this planetary gear.

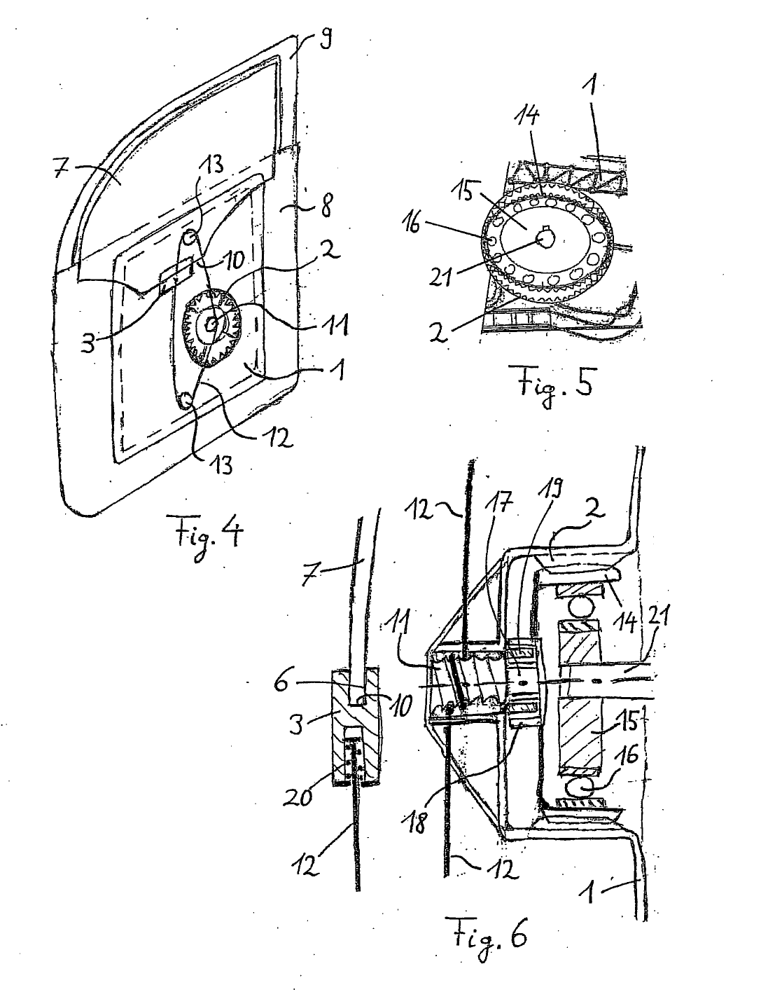

The harmonic drive transmission provided in the present example is again illustrated in more detail in FIG. 5 which shows a view of the dry side of the door module 1. The transmission part 2 which is configured as a ring with inner toothing and is moulded in one piece onto the door module 1 can again be detected. A flexible, externally toothed rolling bush 14 is disposed within the transmission part 2, said bush being pressed at two oppositely situated positions by an oval core 15 which is disposed within the rolling bush 14 against the transmission part 2 serving as support ring and consequently abuts there on the support ring and is in engagement with the inner toothing. Between the core 15 which sits on the drive shaft of the transmission which is connected to the mentioned electric motor, and the rolling bush 14, a ball bearing 16 (also a roller bearing can be used) is provided, which allows rotation of the core 15 with extremely low friction losses. Rotation of the core 15 caused by the electric motor now has the result that the points against which the rolling bush 14 abuts rotate radially. The cylindrical transmission part 2 and the rolling bush 14, which are both toothed, have different numbers of teeth. This has the result, that with rotation of the core 15, rotation of the rolling bush 14 is also effected, even if at a significantly lower rotational speed. The harmonic drive transmission consequently functions in the desired manner as gear reduction transmission. The rolling bush 14, in particular flexible in the radial direction, is thereby connected to a driven shaft, not detectable here, on which the already mentioned drum 11 sits.

A similar embodiment of the invention is represented in FIG. 6 which is configured as a section drawing. Recurring features are again provided here with the same reference numbers. The driven shaft 17 which is connected via a flange 18 to the flexible, externally toothed rolling bush 14 and to the drum 11 and pierces the door module 1 at a point at which the door module 1 is provided with a sliding seal 19 serving as bearing can be detected here. The drive shaft 17 thus connects the harmonic drive transmission which is disposed on the dry side of the door module 1 (on the right in FIG. 6) to the drum 11 which is disposed on the wet side (on the left in FIG. 6) and which, together with the traction rope 12 and two deflection elements which are not detectable in FIG. 6, forms a pulling device for moving the window pane 7. Also an end of the traction rope 12 can be detected which is connected via a spiral spring 20 to the entrainer 3 and can pull the latter downwards for opening the window pane 7. A drive shaft 21 can likewise be detected, on which the core 15 which has a non-constant radius sits, and connects the harmonic drive transmission to a motor, not illustrated here.

As mentioned earlier, it is possible in principle to configure the transmission as a planetary gear. The ring with the inner toothing then serves as external toothed ring of this planetary gear.

However, a high manufacturing precision of the ring with the inner toothing is required in this case in order to ensure the function of the transmission. Advantageously, the plastic material from which the ring with the inner toothing is produced is very abrasion-resistant in order to be able to withstand loading of the inner toothing by the toothed wheels of the planetary gear. There is a danger that, in the course of operation, the inner toothing is abraded by the toothed wheels of the planetary gear and the transmission becomes incapable of functioning.

In contrast, a specific technical manufacturing lack of precision of the ring with the inner toothing 2 is unproblematic in the case of a harmonic drive transmission. As a result of the flexibility of the rolling bush 14 which advantageously is made of a rubber, these imprecisions are compensated for to a certain extent.

In contrast to the planetary gear, the abrasion forces which are exerted on the inner toothing by the rolling bush 14 are small. This applies in particular when the rolling bush is made of rubber. Hence there are no stringent requirements placed upon the abrasion resistance of the inner toothing.

For these mentioned reasons, it is particularly advantageous to configure the ring with inner toothing 2, which comprises plastic material according to the invention and is moulded in one piece onto the module, as support ring for a harmonic drive transmission.

In the case of the embodiments of the invention described with reference to FIGS. 1 to 6, the door module 1 is configured respectively as an injection moulded part which is cast in one operation with the transmission part 2. The production is thereby effected in an injection moulding machine with a cavity which reproduces a desired form of the door module 1 with the transmission part 2. Door modules 1 of the same type can also be produced by a two-component injection moulding process in which the transmission part 2 is formed by a different plastic material component from the actual door module 1 or else by a subsequent injection moulding-on of the transmission part 2. Finally, production of door modules 1 of this type is also possible alternatively by deep drawing or embossing of the door module 1 or of a semi-finished product which forms the door module 1.

1. A module for a vehicle, the module forming a support for a window lifting mechanism, comprising:
at least one toothed transmission part associated with the window lifting mechanism molded in one piece onto the module,
wherein the module is made of a plastic material for separating a wet side from a dry side of the vehicle.

2. The module according to claim 1, wherein the module is one of (i) a door module for a vehicle door and (ii) a side wall module for a vehicle side wall.

3. The module according to claim 1, wherein the module is at least partially made of one of propylene and polyamide.

4. The module according to claim 1, wherein the module is at least partially made of a fiber-reinforced plastic material.

5. The module according to claim 1, wherein the module is an injection molded part.

6. The module according to claim 1, wherein the transmission part comprises at least one toothed rack molded in one piece onto the module.

7. The module according to claim 6, wherein the toothed rack is configured as one of a bead, a web and an L-profile molded onto the module.

8. The module according to claim 6, wherein the toothed rack is disposed on the wet side.

9. The module according to claim 1, wherein the transmission part comprises a ring with an inner toothing molded in one piece onto the module.

10. The module according to claim 9, wherein the ring is disposed on the dry side.

11. A window lifting arrangement for a vehicle, comprising:
a module forming a support for a window lifting mechanism, the module including at least one toothed transmission part associated with the window lifting mechanism molded in one piece onto the module, the transmission part comprising at least one toothed rack molded in one piece onto the module,
wherein the module is made of a plastic material for separating a wet side from a dry side of the vehicle.

12. The window lifting arrangement according to claim 11, wherein the module is one of (i) a door module for a vehicle door and (ii) a side wall module for a vehicle side wall.

13. The window lifting arrangement according to claim 11, further comprising:
an entrainer for a window pane, the entrainer including a motor and a toothed wheel driven by the motor being in engagement with the toothed rack.

14. The window lifting arrangement according to claim 13, wherein the toothed rack is configured as a guide rail for the entrainer.

15. The window lifting arrangement according to claim 13, wherein a rotatable counter-roller is disposed on the entrainer so that the toothed rack is situated between the counter-roller and the toothed wheel.

16. The window lifting arrangement according to claim 11, wherein the module includes a ring with an inner toothing being molded as a transmission part in one piece onto the module.

17. The window lifting arrangement according to claim 16, wherein the ring is part of a gear, the gear having a drive shaft and a driven shaft, the drive shaft connecting to one of (i) a motor and (ii) a crank drive, the driven shaft driving a pulling device for a moveable window pane.

18. The window lifting arrangement according to claim 16, wherein the ring is an external toothed ring of a planetary gear.

19. The window lifting arrangement according to claim 16, wherein the ring is a support ring of a harmonic drive transmission.

20. A vehicle door, comprising:
a door module according to claim 1.

21. A vehicle door, comprising:
a window lifting arrangement according to claim 11.

22. A method for producing a module for a vehicle according to claim 1, comprising:
casting the module with a transmission part in one operation in an injection molding process.

23. A method for producing a module for a vehicle according to claim 1, comprising:
injection-molding a transmission part onto the module.

24. A method for producing a module for a vehicle according to claim 1, comprising:
producing a transmission part by one of a deep drawing and an embossing of one of the module and a flat semi-finished product.
